(19) United States
(12) Patent Application Publication
(10) Pub. No.: US 2007/0218182 A1
(43) Pub. Date: Sep. 20, 2007

(54) Novel Fat Powders

(75) Inventors: Michael Schneider, Freinsheim (DE); Karlheinz Tovar, Erbes-Budesheim (DE); Gerhard Kohn, Worrstadt (DE)

Correspondence Address: THE WEBB LAW FIRM, P.C., 700 KOPPERS BUILDING, 436 SEVENTH AVENUE, PITTSBURGH, PA, 15219, US

(73) Assignee: Omega for Life GmbH, Wendelsheim (DE)

(21) Appl. No.: 10/584,867

(22) PCT Filed: Jun. 14, 2004
(86) PCT No.: PCT/EP04/06373

§ 371 Date: Jun. 29, 2006

(30) Foreign Application Priority Data
Dec. 30, 2003 (DE) 10361667.5

(51) Int. Cl. A23D 9/00; A23L 1/32

(52) U.S. Cl. 426/601; 426/614

(57) ABSTRACT

The present invention relates to fat products based on whole egg or egg yolk which have a high content of triglycerides and/or phospholipids of long-chain polyunsaturated fatty acids having at least 20 carbon atoms and of specific unsaturated C18 fatty acids. These products are distinguished by a low carbohydrate content and a high oxidation stability and bioavailability of the bioactive fatty acids. The fat products are used in the animal and human nutrition sector.

### BACKGROUND

Animal and vegetable fats for human and animal nutrition consist of a large number of different fatty acids. Numerous studies have shown that, among the large number of different fatty acids, some are of little particular physiological importance for the metabolism, while others are used primarily for energy provision and as depot fat.

The physiologically significant bioactive fatty acids include the so-called long-chain polyunsaturated fatty acids of the omega-3 and omega-6 type (LCPUFA having 20 or more carbon atoms). The most prominent representatives of this class of fatty acids are arachidonic acid (ARA; 20-4ω6), eicosapentaenoic acid (EPA; 20-5ω3), docosahexaenoic acid (DHA; 22-6ω3) and docosapentaenoic acid (DPA; 22-5ω3). Other important bioactive fatty acids are special C18 fatty acids, particularly γ-linolenic acid (GLA; 18-3ω6), stearidonic acid (SDA; 18-4ω3) and conjugated linoleic acids (CLA).

Oils and fats with high contents of physiologically valuable bioactive fatty acids, especially long-chain polyunsaturated omega-3 fatty acids (e.g. from fish oils, etc.), are chemically relatively unstable and tend to oxidize even under mild conditions. This means that the incorporation of these oils and fats into industrially produced foods necessitates special processing or requires the addition of natural and/or synthetic antioxidants.

### STATE OF THE ART

For incorporation into foods, oils and fats with high contents of physiologically valuable bioactive fatty acids are nowadays microencapsulated in special processes. This not only makes the oils and fats easier to process, but also results in an improved chemical stability and hence ensures that the manufactured products have better keeping properties.

One disadvantage of microencapsulated oils and fats is the high price due to the use of expensive production technologies. Another disadvantage is the limitation to microencapsulated products with a fat content of about 25 to 30 wt. % of the fat powder dry matter. Furthermore, the microencapsulated oils and fats available hitherto have disadvantages in respect of the physiological value and acceptance of the encapsulating materials (such as gelatin and other proteins) and in respect of the absorption and bioavailability of the encapsulated oils and fats.

The object of the present invention is to provide a stabilized fat product which avoids the microencapsulation technique and can be prepared simply and economically. The fat product should also be capable of having a fat content of more than 30 wt. %, based on the dry matter.

### DESCRIPTION OF THE INVENTION

This object is achieved according to the invention by the provision of a fat product based on whole egg or egg yolk according to Claim 1 or 13.

It was found, surprisingly, that the fat product according to the invention exhibits a high oxidation stability and bioavailability of the long-chain polyunsaturated bioactive fatty acids. The chemical stability of these fat products exceeds the stability of microencapsulated oils and fats produced according to the state of the art. Moreover, it could be established that the bioactive fatty acids based on egg or egg yolk have a higher absorption rate and bioavailability than the pure oils of the corresponding fatty acids. This is attributable inter alia to the high proportion of phospholipids, primarily phosphatidylcholine. Furthermore, the fat products in the form of egg yolk proteins according to the invention contain a substantial proportion of physiologically very high-value proteins and only a very low proportion of cholesterol.

In addition, by virtue of the inexpensive production process, which can also be operated on the industrial scale, the fat products according to the invention can be prepared economically.

Another advantage of the present invention is that it is possible to provide stabilized fat products with a fat or oil content of more than 30 wt. % and preferably of more than 50 wt. %, based on the dry matter.

The fat product according to the invention is based on whole egg or egg yolk, i.e. the non-fat component of the product consists essentially of whole egg or egg yolk constituents. Within the framework of the present invention, it is preferable to use hens' eggs, but it is possible quite generally to use birds' eggs and especially poultry eggs. Egg and egg yolk powders have a variety of uses in the food industry, the individual products being enzymatically or microbially pretreated in some cases (protein, phospholipid and/or carbohydrate degradation) or substances (e.g. salts, carbohydrates, etc.) being specifically added.

The fatty acid component of egg and egg yolk powder has only small contents of bioactive fatty acids. Long-chain polyunsaturated fatty acids (LCPUFA) account for only up to approximately 5 wt. % of the overall fatty acid component of total egg yolk. This is attributable to the fact that LCPUFA occur in egg yolk powder almost exclusively in the form of phospholipids. By using a specific hen feed, the triglycerides, which make up approx. 60 wt. % of the egg yolk fats, can be enriched in their content of polyunsaturated fatty acids having up to 18 carbon atoms, but not LCPUFA. The special fatty acids GLA, SDA and CLA in egg yolk each account for only up to 1 wt. % at most of the total fatty acid component and their proportion can likewise only be increased slightly through the feed.

The fat products according to the invention include a fat or oil component containing triglycerides and/or phospholipids of long-chain polyunsaturated fatty acids having at least 20 carbon atoms, the proportion of long-chain polyunsaturated fatty acids having at least 20 carbon atoms being more than 5 wt. %, especially more than 6 wt. %, preferably 10 to 70 wt. %, particularly preferably 15 to 50 wt. % and very particularly preferably 20 to 30 wt. % of the total fatty acids. Within the framework of the present invention, the expression ‘fat or oil content’ is understood as meaning the so-called total fat content (total lipid content) under which all the possible fats or lipoids are classified, such as oils, fats (triglycerides), phospholipids, glycolipids, sphingolipids, sterols, fat-soluble vitamins, etc.

The long-chain polyunsaturated fatty acids are omega-3 and omega-6 fatty acids having at least 20 carbon atoms, preferably 20 or 22 carbon atoms. These fatty acids preferably have 4, 5 or 6 C—C double bonds. The most prominent representatives of this class of fatty acids are arachidonic acid (ARA; 20-4ω6), eicosapentaenoic acid (EPA; 20-5ω3), docosahexaenoic acid (DHA; 22-6ω3) and docosapentaenoic acid (DPA; 22-5ω3). In addition, the fat and oil component can also contain other fatty acid phospholipids and/or fatty acid triglycerides. These fatty acids are saturated or mono- or polyunsaturated fatty acids such as the ones generally known to those skilled in the art.

The fat products according to the invention can also comprise conventional known additives, e.g. stabilizers, preservatives, antioxidants, flavourings and/or other oil-soluble nutrients (such as beta-carotene, lutein, lycopene, coenzyme Q10, astaxanthin, etc.).

The fat or oil content of the fat products according to the invention is more than 10 wt. %, preferably more than 30 wt. % and particularly preferably more than 50 wt. %, based on the dry matter. The fat or oil content is preferably between 50 and 60 wt. %.

The fat product according to the invention is preferably in solid form. Solid forms include e.g. powders, granules, agglomerates or else grit of different particle sizes. The fat product is preferably in powder form. The fat products according to the invention can also be in liquid form.

In one preferred embodiment, the fat or oil component containing long-chain polyunsaturated fatty acids originates from animal fat, marine oils and fermentation oils. These include especially fish oil, marine animal oil, marine mammal oils, e.g. seal oil, bacterial oils, algal oils, fungal oils or single-cell oils. Examples of fish oils which can be used are mackerel oil, salmon oil, tuna oil, herring oil and sardine oil. It is preferable to use tuna oil, fish oil, single-cell oil or seal oil. Mixtures of these can also be used. It is also possible to use synthetic fats or oils containing long-chain polyunsaturated fatty acids. Vegetable oils, on the other hand, contain no long-chain polyunsaturated fatty acids having at least 20 carbon atoms.

Furthermore, the fat product according to the invention has a carbohydrate content preferably of at most 15 wt. %, particularly preferably of at most 10 wt. % and especially of at most 5 wt. %.

The fat products according to the invention can advantageously be employed in the manufacture of products for the human nutrition sector as well as for the animal nutrition sector.

In the human nutrition sector, use of the fat powders according to the invention makes it possible to provide foods, food supplements and special diets with a high content of long-chain polyunsaturated fatty acids having at least 20 carbon atoms. The invention further relates to foods, food supplements and special diets containing the fat product according to the invention.

As distinct from conventional fat powders, which are frequently produced on the basis of modified starches, maltodextrins and the like, use of the fat products according to the invention additionally makes it possible to produce foods that are poor in carbohydrate but enriched in bioactive fatty acids, and hence e.g. to satisfy the requirements of low-carb diets (such as the Atkins diet, the Agatson diet, the South Beach diet and the Glyx diet).

As well as being used in the human nutrition sector for the production of traditional and novel foods (functional foods) and food supplements and special diets, the fat products according to the invention can also be used in the animal nutrition sector and the special animal food supplement sector.

This further use applies both to solid fat products based on whole egg or egg yolk comprising a fat or oil component containing triglycerides and/or phospholipids of long-chain polyunsaturated fatty acids having at least 20 carbon atoms, and to solid fat products based on whole egg or egg yolk comprising a fat or oil component containing triglycerides and/or phospholipids of γ-linolenic acid, stearidonic acid and/or conjugated linoleic acid.

The animal nutrition sector in which the products may be used includes the following, inter alia:
feed for slaughter animals (pig, piglet, cow, calf, rabbit, hare, etc.)
food for domestic animals (dog, cat, etc.)
feed for horses used for sport (jumping, racing, dressage)
food for racing dogs
food for aquarium fish
food for farmed fish (salmon, cod, sea bream, mackerel shark, etc.)
food for other types of aquaculture (prawn, crab, etc.)
rearing food for juvenile fish and animals used as fish food (artemia, rotifer, etc.)

In said application sectors of animal nutrition, the fat powders according to the invention can be employed e.g. in permanent feed, in rearing feed for juvenile animals, in special feed for pregnant and suckling females, and other special feeds. The invention further relates to animal feeds containing the fat product according to the invention.

To prepare the fat products according to the invention, the endogenous fat component of the whole egg or egg yolk is replaced with a fat or oil component containing triglycerides and/or phospholipids of long-chain polyunsaturated fatty acids. More precisely, the egg oil (triglyceride) plus cholesterol present in the egg yolk in a proportion of approx. 35 to 40 wt. %, based on the dry matter, is removed to the greatest possible extent and replaced with fats or oils which have the desired composition and the desired content of long-chain polyunsaturated bioactive fatty acids. As indicated previously, these are preferably animal fat, marine oils, fermentation oils, special vegetable oils and/or mixtures thereof.

Conventionally, the starting material for the preparation of the fat products, especially the fat powders, is preferably either liquid or spray-dried egg yolk. In the case of liquid egg yolk, the endogenously present egg oil can be removed by centrifugal separation techniques (possibly after breaking of the emulsion). The desired fat or oil or the fat or oil mixtures are added to the liquid egg yolk from which the oil has been removed, the former usually being stabilized with suitable antioxidants (e.g. vitamin E, ascorbyl palmitate, rosemary extracts, green tea extracts or the like). The homogeneous mixture of the two components can then be dried by suitable methods known to those skilled in the art, e.g. by means of spray drying or freeze drying, it being possible for the particle size and the flow properties to be specifically adjusted, if appropriate, by other process steps, such as agglomeration or grinding, with which those skilled in the art are generally familiar. The solid fat product is preferably in powder form, but products in the form of granules or grit, for example, can also be obtained by suitable processing methods.

In the preparation of the fat powders starting from spray-dried egg yolk, the endogenously present egg oil can be removed in a one-stage or multi-stage process and replaced with the oil or fat. Such processes are known to those skilled in the art and, in addition to extraction with supercritical gases (e.g. CO₂ high pressure extraction), also include e.g. a pressing process where the oil-based treating agent is pressed through the dry egg product. Subsequent drying processes are not usually necessary with this procedure, but can optionally be carried out. The particle size and the flow properties can be specifically adjusted in the manner stated above.

The invention further relates to the observation that the use of whole egg or egg yolk contributes to the stabilization of fat or oil. This stabilization method is particularly suitable for the stabilization of fat or oil containing biologically active fatty acids such as long-chain polyunsaturated fatty acids with a chain length of 18 to 22 carbon atoms.

The invention further relates to fat products based on whole egg or egg yolk which comprise a fat or oil component containing triglycerides and/or phospholipids of γ-linolenic acid, stearidonic acid and/or conjugated linoleic acid, the proportion of at least one of these fatty acids being more than 1 wt. %, especially more than 2 wt. %, preferably 5 to 70 wt. %, particularly preferably 10 to 50 wt. % and very particularly preferably 20 to 40 wt. % of the total fatty acids. In one preferred embodiment, this oil component originates from special vegetable oils, e.g. borage oil or vegetable oil with a high CLA content, which can be prepared e.g. from plant raw materials by chemical or enzymatic methods. The isomers of the conjugated linoleic acid are especially 9,11-c/t-linoleic acid (CLA) and 10,12-t/c-linoleic acid (CLA).

Reference is made to the above remarks as regards preferred embodiments of the fat products containing δ-linolenic acid, stearidonic acid and/or conjugated linoleic acid, their use in foods, the process for the preparation of these fat products and the use of whole egg or egg yolk for the stabilization of fat or oil containing triglycerides of these fatty acids.

### EXAMPLES

The invention is illustrated in greater detail below with the aid of Examples. The overall fatty acid compositions of the fat products from the Examples are reproduced in the Table.

### Example 1

Fat Powder with a High Content of Eicosapentaenoic Acid (EPA) and Docosahexaenoic Acid (DHA), Based on Seal Oil

The fat product based on egg yolk was prepared by separating the egg oil from the liquid egg yolk by means of a centrifugal separation process. Seal oil was then added in a ratio of 2:1 (v/v) to the egg yolk from which the oil had been removed, and the product was homogenized and then dried by freeze drying.

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using seal oil, the proportion of EPA is approx. 5.2 wt. %, that of DPA approx. wt. % and that of DHA approx. wt. % of the total fatty acids.

### Example 2

Fat Powder with a High Content of Docosahexaenoic Acid, Based on Tuna Oil

The fat product based on egg yolk was prepared by separating the egg oil from the liquid egg yolk by means of a centrifugal separation process. Tuna oil was then added in a ratio of 2:1 (v/v) to the egg yolk from which the oil had been removed, and the product was homogenized and then dried by freeze drying.

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using tuna oil, the proportion of EPA is approx. 4.3 wt. % and that of DHA approx. 20.3 wt. % of the total fatty acids.

### Example 3

Fat Powder with a High Content of Eicosapentaenoic Acid and Docosahexaenoic Acid, Based on Fish Oil

The fat product based on egg yolk was prepared as described in Example 2, except that the tuna oil was replaced with an EPA-rich fish oil of South American origin (anchovy, mackerel).

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using a fish oil, the proportion of EPA is approx. 13.7 wt. % and that of DHA approx. 10 wt. % of the total fatty acids.

### Example 4

Fat Powder with a High Content of Docosahexaenoic Acid, Based on Single-Cell Oil

The fat product based on egg yolk was prepared as described in Example 1, except that the seal oil was replaced with a DHA-rich single-cell oil (microalgae).

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using a microbial oil, the proportion of DPA is approx. 12 wt. % and that of DHA approx. 30 wt. % of the total fatty acids.

### Example 5

Fat Powder with a High Content of Conjugated Linoleic Acid (ω3-LCPUFA)

The fat product based on egg yolk was prepared as described in Example 1, except that the seal oil was replaced with a CLA-rich vegetable oil.

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using a specific vegetable oil with a high CLA content, the proportion of CLA, especially the isomers 9,11-c/t-linoleic acid (CLA) and 10,12-t/c-linoleic acid (CLA), is approx. 60 wt. % of the total fatty acids.

### Example 6

Fat Powder with a High Content of Gamma-Linolenic Acid (ω6-PUFA)

The fat product based on egg yolk was prepared as described in Example 1, except that the seal oil was replaced with a GLA-rich borage oil.

The product obtained has a fat content of more than 50 wt. % of the dry matter, which is made up of about 35 wt. % of phospholipids and about 65 wt. % of triglycerides. The protein content is approx. 40 wt. % of the dry matter. By virtue of using a special vegetable oil (borage oil), the proportion of GLA is approx. 19 wt. % of the total fatty acids.

TABLE 1
Composition of the fat powders from the Examples

| | | | | Ex. 4 | | Ex. 6 |
|---|---|---|---|---|---|---|
| | Ex. 1 | Ex. 2 | Ex. 3 | single- | Ex. 5 | borage |
| | seal oil | tuna oil | fish oil | cell oil | CLA oil | oil |
| Parameter | powder | powder | powder | powder | powder | powder |
| Fatty acid | | | | | | |
| 14-0 | 3.2 | 2.6 | 5.1 | 5.7 | | |
| 16-0 | 12.8 | 21.5 | 19.5 | 24.3 | 9.5 | 13.8 |
| 18-0 | 4.8 | 8.0 | 6.5 | 4.6 | 6.2 | 6.2 |
| 18-1 | 25.1 | 16.4 | 15.8 | 7.1 | 16 | 17.2 |
| 18-2ω6 | 6.1 | 6.3 | 6.0 | 5.2 | 6.3 | 34.3 |
| 18-3ω3 | 0.5 | 0.7 | 0.7 | 0.3 | 0.1 | 0.1 |
| 18-3ω6 | 0.1 | 0.2 | | | | 18.9 |
| 20-4ω6 | 1.9 | 3.0 | 1.6 | 2.3 | 1.6 | 1.6 |
| 20-5ω3 | 5.2 | 4.3 | 13.7 | 1.8 | | |
| 22-5ω6 | | | | 11.9 | | |
| 22-5ω3 | 3.0 | 0.9 | 0.1 | 0.1 | 0.1 | 0.1 |
| 22-6ω3 | 7.2 | 20.3 | 10.1 | 29.9 | 0.9 | 0.9 |
| Total CLA | | | | | 59.9 | |

### Example 7

A fat powder product according to the invention for the animal feed sector is illustrated below by way of example. The product composition is reproduced in Table 2.

This fat powder rich in eicosapentaenoic acid (EPA) and docosahexaenoic acid (DHA) was prepared by physical replacement of the endogenously present egg oil with an EPA/DHA-rich fish oil by means of a pressing process followed by grinding. The product obtained has a fat content of more than 60 wt. % of the dry matter, at least 10% of the dry matter being in the form of phospholipids. The protein content is at 15 least 30% of the dry matter. By virtue of the type of fish oil used, the EPA content is approx. 3% and the DHA content approx. 5% of the dry matter (corresponding to respective proportions of approx. 6% and 8% of the total fatty acids).

TABLE 2
Omega-3-rich fat powder for the animal feed sector (juvenile animal
rearing)

| | | |
|---|---|---|
| Composition: | Fish oil | |
| | Vegetable oil | |
| | Egg yolk | |
| Analytical data: | Total fat | >60% DM |
| | Protein | >30% DM |
| | Lecithin | >10% DM |
| | Carbohydrates | <5% DM |
| | Residual moisture | <5% DM |
| | Cholesterol | <1% DM |
| Fatty acid content: | EPA (20-5ω3) | approx. 3% DM |
| | DHA (22-6ω3) | approx. 5% DM |
| | Total omega-3 content | approx. 10% DM |
| Physicochemical parameters: | Colour | yellowish |
| | Solubility | water-soluble |
| | Taste | typical |

1-20. (canceled)

21. A solid fat product based on whole egg or egg yolk which includes a fat or oil component, comprising:
the fat or oil component containing phospholipids originating from the whole egg or egg yolk; and
long-chain polyunsaturated fatty acids having at least 20 carbon atoms present in the fat or oil component in an amount of more than 5 wt. % of the total fatty acid content.

22. The solid fat product according to claim 21, wherein the proportion of phospholipids originating from the whole egg or egg yolk is up to about 35 wt. % of the fat or oil component.

23. The solid fat product according to claim 21, wherein the solid fat product is in powder form.

24. The solid fat product according to claim 21, wherein the long-chain polyunsaturated fatty acids are selected from the group consisting of arachidonic acid, eicosapentaenoic acid, docosahexaenoic acid, docosapentaenoic acid and mixtures thereof.

25. The solid fat product according to claim 21, further comprising the inclusion of other fatty acid phospholipids, fatty acid triglycerides and/or antioxidants.

26. The solid fat product according to claim 21, wherein the solid fat product has a carbohydrate content of at most 15 wt. %, based on the fat product dry matter.

27. The solid fat product according to claim 21, wherein the solid fat product has a carbohydrate content of at most 5 wt. %, based on the fat product dry matter.

28. The solid fat product according to claim 21, wherein the solid fat product has a fat or oil content of more than 30 wt. %, based on the fat product dry matter.

29. The solid fat product according to claim 21, wherein at least part of the fat or oil component originates from a fat or oil component selected from the group consisting of an animal fat, fish oil, marine animal oil, fermentation oil, single-cell oil and mixtures thereof.

30. A method for the preparation of a solid fat product according to claim 21, wherein the egg oil is separated from the whole egg or egg yolk and replaced with a fat or oil component containing triglycerides and/or phospholipids of long-chain polyunsaturated fatty acids having at least 20 carbon atoms, the proportion of long-chain polyunsaturated fatty acids having at least 20 carbon atoms being more than 5 wt. % of the total fatty acid content.
